(19) United States
(12) Patent Application Publication
(10) Pub. No.: US 2006/0052147 A1
(43) Pub. Date: Mar. 9, 2006

(54) Athletic game learning tool, capture system, and simulator

(76) Inventor: Robin Matthews, Cockeysville, MD (US)

Correspondence Address: Armstrong Kratz, Quintos;Hanson & Brooks, Suite 220, 502 Washington Avenue, Towson, MD, 21204, US

(21) Appl. No.: 10/518,865

(22) PCT Filed: Jun. 18, 2003
(86) PCT No.: PCT/US03/19185

§ 371 Date: Feb. 9, 2005

Related U.S. Application Data
(60) Provisional application No. 60/390,812, filed on Jun. 20, 2002.

(51) Int. Cl. A63F 13/00

(52) U.S. Cl. 463/4

(57) ABSTRACT

A system and method is provided for simulating an athletic event. This system and method begins by entering players for positions (630) in a squad on an offensive, defensive or special team, wherein each player has vital statistics, general attributes (640), offensive/defensive attributes (650) and specialized attributes (660) which predict athletic performance associated therewith. Players are then placed in a formation. A play is then established based on the formation in which the moving pattern and activity of each player is defined. The play is then simulated by having each player executing the moving pattern and activity, as modified by the vital statistics, general attributes (640), offensive/defensive attributes (660) associated with each player.

### This application claims the benefit of U.S. Provisional Application No. 60/390,812, filed Jun. 20, 2002, the disclosure of which is incorporated by reference herein in its entirety.

### FIELD OF THE INVENTION

The present invention relates to an athletic game teaching, learning tool, capture system and simulator and, in particular, to a system in which plays may be entered and simulated based upon specific players assigned to specific positions having unique attributes that influence and determine the outcomes of the plays being simulated and allows import of data from real world situations.

### BACKGROUND OF THE INVENTION

Computer-implemented games are numerous and have become extremely popular. These games typically provide for a predetermined number of plays that each team in an athletic game may execute. The plays are then executed based upon probabilities associated with each play. The changing positions of players may be observed during execution of the play.

One such game is disclosed in U.S. Pat. No. 4,304,404 issued to Pundt.

This device discloses a method of sequentially observing player positions in predetermined game plays. The device includes a player position matrix having a number of indicia for designating various player positions. These positions are adapted to be sequentially operated to designate the changing positions of players during a given play. Unfortunately, this device is limited to predetermined plays and is unable to simulate play results based upon input of individual player attributes. Therefore, simulation of a play based upon individual player capabilities is not possible.

Another such game is disclosed by U.S. Pat. No. 4,918,603 to Hughes et al. Hughes et al. discloses a computerized statistical football game based upon actual game data. Individual football franchises are set up, actual football players are drafted by each franchise, and starting player rosters are selected from those players. The player performances are scored based upon actual game scores, and the franchises calculate a composite win or loss score from a total of the actual individual scores of the football players. However, this game is unable to enter or execute individual plays and simulate the outcome of plays based upon individual player attributes. Further, digital films of actual plays from real games may not be imported into the system for review and simulation.

While being useful for their purposes, none of the games provides entry of individual plays as would be depicted in a team playbook. Further, no provision is made for the entry of individual players along with their respective attributes. Still further the outcome of plays based upon individual players in specific positions utilizing the attributes for these players is not contemplated. Still further, the prior art does not provide any means for player training without resorting to actual practice seasons where the players are exposed to injuries. Finally, incorporating actual digital video images of actual game plays into the simulation with camera views from specific player views is not provided.

Therefore, a need exists for a system that provides entry of plays and specific players along with their individual attributes in specific positions. The system should simulate these plays based upon the attributes of each player in each position. The system should allow for viewing the results of games from a two-dimensional and three-dimensional view utilizing animated players. The system should also import actual game footage into the simulation so that play results may be analyzed in plays or players changed.

### SUMMARY OF THE INVENTION

An embodiment of the present invention is to provide for a method of simulating an athletic event. This method begins by entering players for positions in a squad on an offensive, defensive or special team, wherein each player has vital statistics, general attributes, offensive/defensive attributes and specialized attributes which predict athletic performance associated therewith. Players are then placed in a formation. A play is then established based on the formation in which the moving pattern and activity of each player is defined. The play is then simulated by having each player executing the moving pattern and activity as modified by the vital statistics, general attributes, offensive/defensive attributes and specialized attributes associated with each player. The outcome of the play is based upon the moving patterns and activities as modified by the vital statistics, general attributes, offensive/defensive attributes and specialized attributes associated with each player.

Another embodiment of the present invention is a system and computer program for simulating an athletic event. This system and computer program includes a player module to enter players for positions in a squad on an offensive, defensive or special team. Each player has vital statistics, general attributes, offensive/defensive attributes and specialized attributes which predict athletic performance. This system and computer program also has a play module to establish a play based on a formation in which the moving pattern and activity of each player is defined. Finally, a run designed play module is provided to simulate the play by having each player executing the moving pattern and activity as modified by the vital statistics, general attributes, offensive/defensive attributes and specialized attributes associated with each player. The outcome of the play is based upon the moving patterns and activities as modified by the vital statistics, general attributes, offensive/defensive attributes and specialized attributes associated with each player.

Another embodiment of the present invention is a method for capturing real world plays and importing these real world plays in digital format for viewing in different modes. This method begins by recording and converting video images into digitally formatted images. Thereafter, individual players are identified and tracked in the digitally formatted images. Finally, the digitally formatted images are viewed and individual players highlighted from one scene to the next.

Another embodiment of the present invention is a system and computer program for capturing real world plays and importing these real world plays in digital format for viewing in different modes. This system and computer program includes a digital capture module to record and convert video images into digitally formatted images. A capture module is provided to identify and track individual players in the digitally formatted images. Finally, a run actual play module is provided to view the digitally formatted images and highlight individual players from one scene to the next.

Another embodiment of the present invention is a method of simulating at least a portion of an athletic game or sport and for at least one player on a team participating in that game or sport, thereby facilitating the training of the one player under simulated game conditions and in the classroom rather than on the playing field or arena, and thereby substantially compressing the training time while avoiding a potential injury to the one player on the practice field or arena. This method begins by presenting at least one of the team's defensive or offensive formations and intended subsequent play. Thereafter, this method proceeds to present the team's opponent's likely action or reaction in response thereto, respectively; such that the first and second presentations are viewed from the position of said one player's own eyes had said one player been on the playing field or arena rather than from the perspective of a spectator.

An embodiment of the present invention is to provide for a method of simulating an athletic event. This method begins by entering players for positions in a squad on an offensive, defensive or special team, wherein each player has vital statistics, general attributes, offensive/defensive attributes and specialized attributes which predict athletic performance associated therewith. Players are then placed in a formation. A play is then established based on the formation in which the moving pattern and activity of at least one being defined. The play is the simulated by having the at least one player executing the moving pattern and activity as modified by the vital statistics, general attributes, offensive/defensive attributes and specialized attributes associated with the at least one player. The outcome of the play is based upon the moving patterns and activities as modified by the vital statistics, general attributes, offensive/defensive attributes and specialized attributes associated with the at least one player.

Another embodiment of the present invention is a system and computer program for simulating an athletic event. This system and computer program includes a player module to enter players for positions in a squad on an offensive, defensive or special team. At least one player has vital statistics, general attributes, offensive/defensive attributes and specialized attributes which predict athletic performance. This system and computer program also has a play module to establish a play based on a formation in which the moving pattern and activity of the at least one player being defined. Finally, a run designed play module is provided to simulate the play by having the at least one player executing the moving pattern and activity as modified by the vital statistics, general attributes, offensive/defensive attributes and specialized attributes associated with each player. The outcome of the play is based upon the moving patterns and activities as modified by the vital statistics, general attributes, offensive/defensive attributes and specialized attributes associated with the at least one player.

### BRIEF DESCRIPTION OF THE DRAWINGS

The foregoing and a better understanding of the present invention will become apparent from the following detailed description of exemplary embodiments and the claims when read in connection with the accompanying drawings, all forming a part of the disclosure of this invention. While the foregoing and following written and illustrated disclosure focuses on disclosing example embodiments of the invention, it should be understood that the same is by way of illustration and example only and the invention is not limited thereto. The spirit and scope of the present invention are limited only by the terms of the appended claims.

The following represents brief descriptions of the drawings, wherein:

FIG. 1 is a hardware configuration diagram of a system viewer used in an embodiment of the present invention;

FIG. 2 is a hardware configuration diagram of a digital image capture system utilized in an embodiment of the present invention;

FIG. 3 is a software modular configuration diagram of the plays creation module (300) used in an embodiment of the present invention;

FIG. 4 is a software modular configuration diagram of the viewing module (400) used in an embodiment of the present invention;

FIG. 5 is a software modular configuration diagram of the digital movie module (500) used in an embodiment of the present invention;

FIG. 6 is a flowchart of the player module (310) implemented for the plays creation module (300) shown in FIG. 3 in an example embodiment of the present invention;

FIG. 7 is a flowchart of the squad creation module (320) implemented for the plays creation module (300) shown in FIG. 3 in an example embodiment of the present invention,

FIG. 8 is a flowchart of the formation module (330) implemented for the plays creation module (300) shown in FIG. 3 in an example embodiment of the present invention;

FIG. 9 is a flowchart of the play module (340) implemented for the plays creation module (300) shown in FIG. 3 in an example embodiment of the present invention;

FIG. 10 is a flowchart of the playbook module (360) implemented for the plays creation module (300) shown in FIG. 3 in an example embodiment of the present invention;

FIG. 11 is a flowchart of the run designed play module (350) implemented for the plays creation module (300) shown in FIG. 3 in an example embodiment of the present invention;

FIG. 12 is a flowchart of the player specific camera viewing module (410) implemented for the viewing module (400) shown in FIG. 4 in an example embodiment of the present invention;

FIG. 13 is a flowchart of the exporting play viewing module (420) implemented for the viewing module (400) shown in FIG. 4 in an example embodiment of the present invention;

FIG. 14 is a flowchart of the digital capture module (510) implemented for the digital movie module (500) shown in FIG. 5 in an example embodiment of the present invention,

FIG. 15 is a flowchart of the capture module (520) implemented for the digital movie module (500) shown in FIG. 5 in an example embodiment of the present invention; and

FIG. 16 is a flowchart of the run actual play module (530) implemented for the digital movie module (500) shown in FIG. 5 in an example embodiment of the present invention.

### DETAILED DESCRIPTION OF THE PREFERRED EMBODIMENTS

Before beginning a detailed description of the subject invention, mention of the following is in order. When appropriate, like reference numerals and characters may be used to designate identical, corresponding or similar components in differing figure drawings. Further, in the detailed description to follow, exemplary sizes/models/values/ranges may be given, although the present invention is not limited to the same.

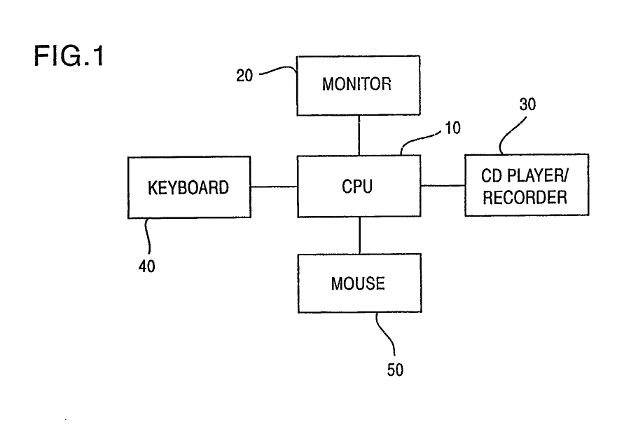

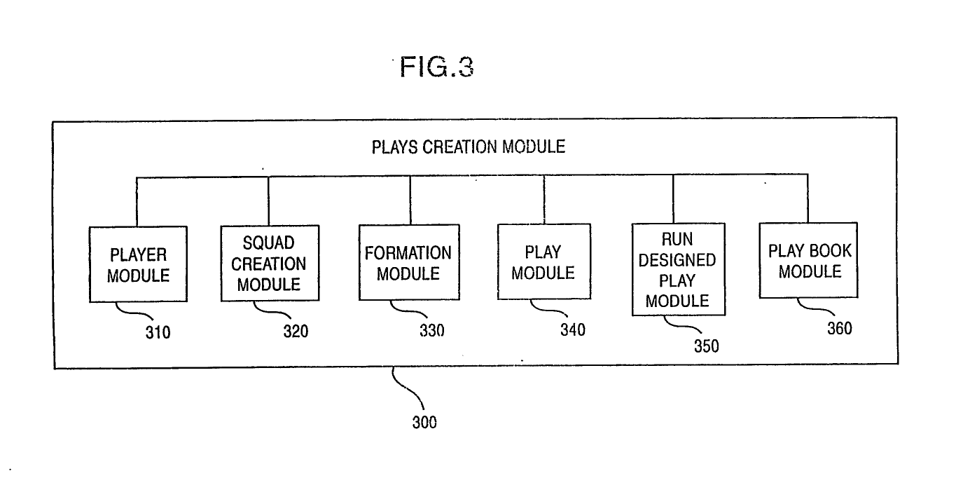

FIG. 1 is a hardware configuration diagram of a system viewer used in an embodiment of the present invention. The system viewer is a typical personal computer having a central processing unit (CPU) (10) including memory (not shown). The system viewer would also include a monitor (20), a keyboard (40) a CD (compact disk)/DVD (Digital Video Disk) or similar media player/recorder (30) and a mouse (50). This system viewer would be utilized to create the plays to be run, enter players and player attributes, run simulations and import actual game footage into simulations as discussed in further detail in FIGS. 3-16.

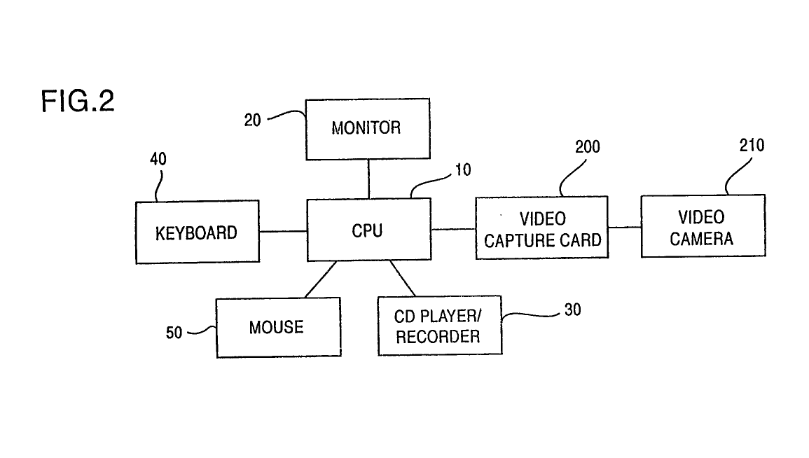

FIG. 2 is a hardware configuration diagram of a digital image capture system utilized in an embodiment of the present invention. This digital image capture system utilizes a standard personal computer having a CPU (10) having memory (not shown), a monitor (20), a CD/DVD or similar media player/recorder (30), a keyboard (40), and a mouse (50). In addition, the digital image capture system would include a video camera (210) and a video capture card (200). This video camera (210) would be utilized to record actual game footage which would be digitized and possibly edited for import into the digital movie module (500) that will be discussed in further detail ahead.

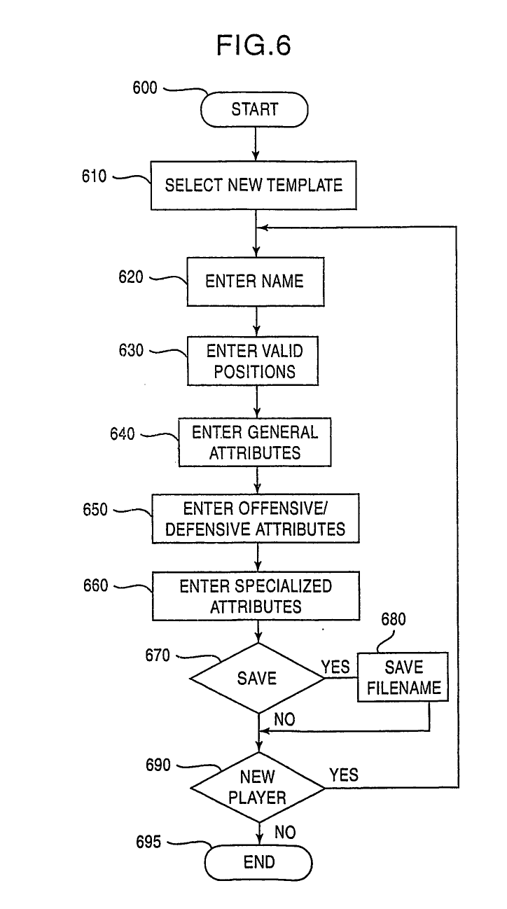

A discussion will now be supplied involving the logic employed in the embodiments of the present invention. Specifically, a discussion will be provided of the flowcharts and diagrams illustrated in FIGS. 6 through 16 and the modular configuration diagrams provided in FIGS. 3-5. The flowcharts and diagrams shown in FIGS. 6 through 16, as well as the modular configuration diagrams shown in FIGS. 3-5 contain operations that correspond, for example, to code, sections of code, instructions, firmware, hardware, commands or the like, of a computer program that is embodied, for example, on a storage medium such as floppy disk, CD Rom, DVD or similar EP Rom, hard disk, RAM etc. Further, the computer program can be written in any computer language such as, but not limited to, for example C++.

Further, throughout this document American football is used as an example of how the techniques, operations and concepts of the present invention may be applied. However, the techniques, operations and concepts employed by the present invention may be utilized for any professional or amateur sport or pastime, including but not limited to baseball, basketball, soccer, hockey, golf, lacrosse, etc.

FIG. 3 is a software modular configuration diagram of the plays creation module (300) used in an embodiment of the present invention. The plays creation module (300) contains all the software required to create plays which are simulated utilizing actual player attributes. The plays creation module (300) includes a player module (310), a squad creation module (320), a formation module (330), a play module (340), a run designated play module (350) and a playbook module (360). The individual components of the play creation module (300) will be discussed in further detail in FIGS. 6-11.

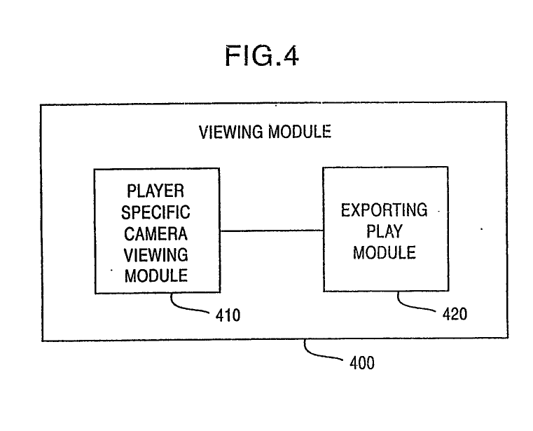

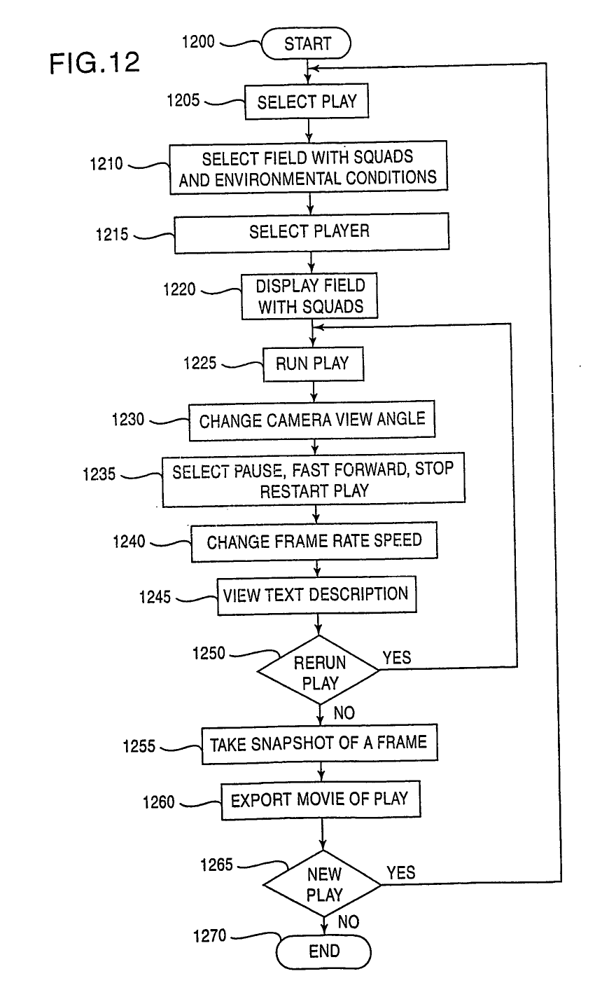

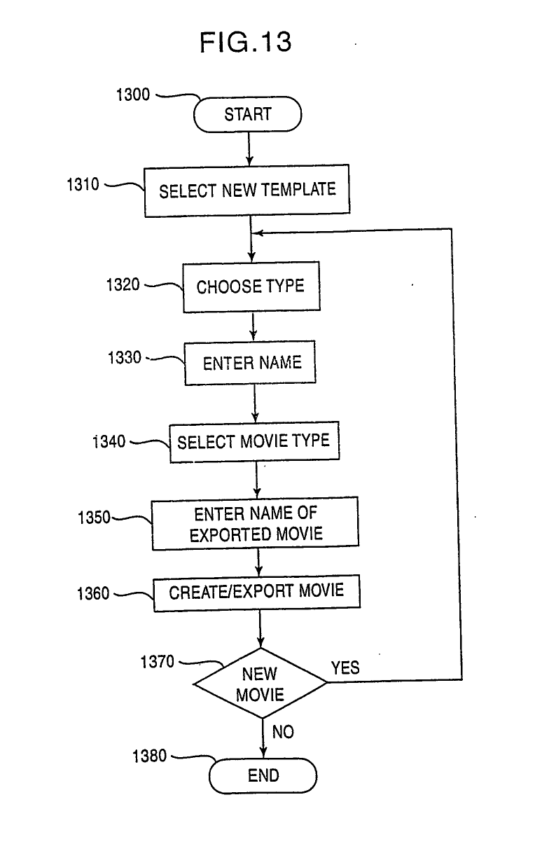

FIG. 4 is a software modular configuration diagram of the viewing module (400) used in an embodiment of the present invention. The viewing module (400) is utilized to view plays created by the plays creation module (300) from specific camera angles and to export these plays in a movie format for viewing as a training tool. The viewing module (400) includes the player specific camera viewing module (410) and the exporting play module (420). These modules will be discussed in further detail in FIGS. 12 and 13 ahead.

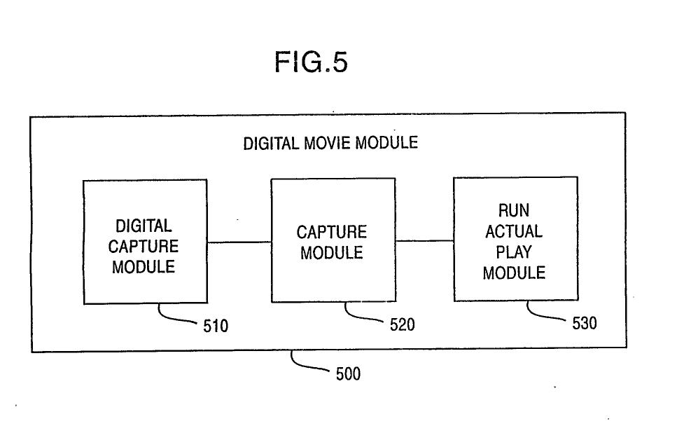

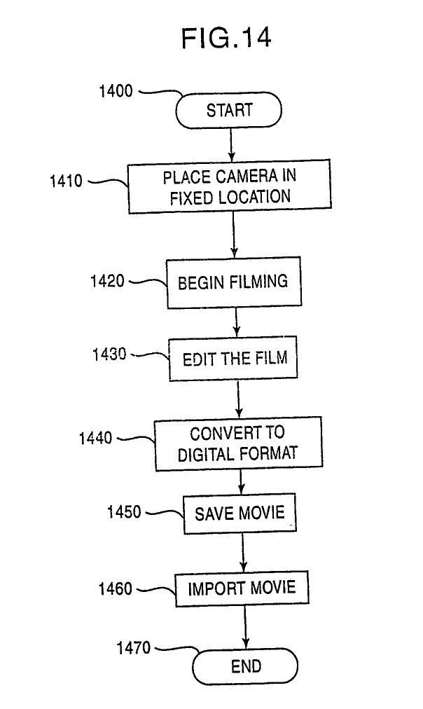

FIG. 5 is a software modular configuration diagram of the digital movie module (500) used in an embodiment of the present invention. The digital movie module (500) is utilized to capture actual real world plays and import them into the remainder of the system. The digital movie module (500) includes a digital capture module (510), a capture module (520) and a run actual play module (530). These modules will be discussed in further detail in reference to FIGS. 14-16 ahead.

FIG. 6 is a flowchart of the player module (310) implemented for the plays creation module (300) shown in FIG. 3 in an example embodiment of the present invention. The player module (310) is utilized to enter all the pertinent information relating to a player's abilities so that once plays are run the plays accurately reflect the player's true skills. Further, the player module (310) may be utilized to reflect temporary injuries or ailments that a particular player may be experiencing.

The player module (310) begins execution in operation 600 and immediately proceeds to operation 610. In operation 610 a template is selected for displaying to the user which would include all the fields required by the player module (310). Processing then proceeds to operation 620 where the player named is entered into the appropriate field. In operation 630 the valid positions that the player may play are entered into the system. Thereafter, in operation 640 general attributes associated with the player may be entered. These general attributes may include vital statistics such as height and weight. In operation 650 offensive and defensive attributes concerning the player may be entered. Then in operation 660 specialized attributes related to the player may be entered. By way of example a list of attributes that may be entered in operations 640-660 is provided in Table 1. This list of attributes is not exhaustive of all possible attributes that may be associated with a player. Further, as would be understood by one of ordinary skill in the art these attributes may vary according to the game being played.

TABLE 1

| Attributes | Description |
|---|---|
| Acceleration | Ability to reach top speed |
| Agility | Ability to movie letter only, avoid tackles |
| Awareness | Awareness of surroundings |
| Breaking tackles | Yards after contact |
| Catching | Ability to hold onto a pass |
| Height | Players height |
| Injury | Toughness, ability to play hurt |
| Jumping | Overall vertical leap |
| Kicking | Taking accuracy |
| Kicking power | Overall distance the ball can be kicked |
| Kicking elevation | Speed of elevation |
| Overall | Overall player rating |
| Pass blocking | Ability to maintain a pass block |
| Run blocking | Ability to maintain a run block |
| Run block reach | Reach |
| Run block drive | Drive cut off |
| Run block pull | Pull in space |
| Speed | Overall top speed |
| Stamina | Ability to retain energy |
| Strength | Overall upper body strength |
| Tackling | Ability to make a tackle |
| Tackle closing speed | Closing speed |
| Tackle closing space | In space pursuit |
| Tackling strength | Strength after contact |
| Throwing accuracy | Ability to hit the intended receiver |
| Throwing power | Overall distance the ball can be thrown |
| Toughness | Ability to recover from injury |
| Weight | Players weight |
| Quickness | Player speed |
| Instinct | Ability to adjust to the opposition |
| Experience | |
| Fatigue | |
| Adrenalin | |

Once the player attributes have been entered processing proceeds to operation 670 where it is determined whether the foregoing entered data should be saved. If in operation 670 it is determined that the data should be saved then processing proceeds to operation 680 where the data is saved under a filename associated with the player. Processing then proceeds from operation 670 and 680 to operation 690 where it is determined if new player data should be entered. If new player data should be entered then processing loops back to operation 620. If no new player data is to be entered then processing proceeds to operation 695 where processing terminates.

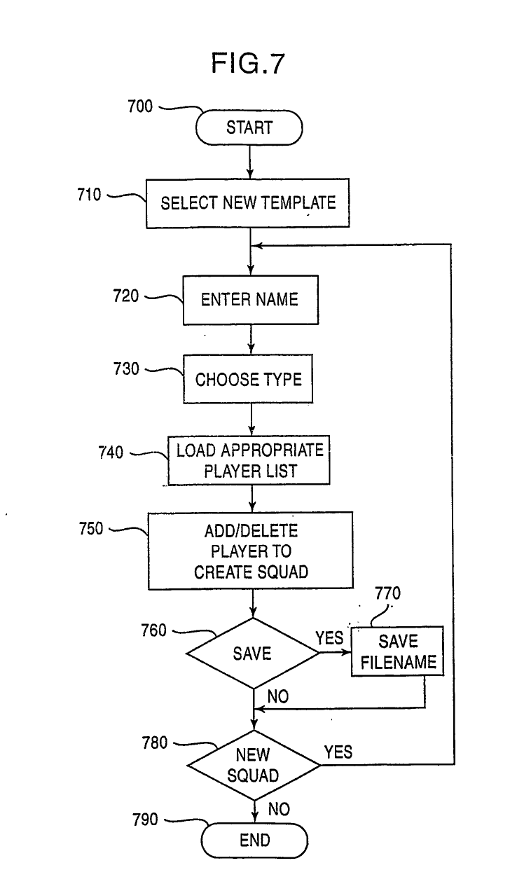

FIG. 7 is a flowchart of the squad creation module (320) implemented for the plays creation module (300) shown in FIG. 3 in an example embodiment of the present invention. The squad creation module (320) is designed to create initial squad's or groupings of players so as to make the running of plays simpler as discussed ahead. The squad creation module (320) begins execution in operation 700 and immediately proceeds to operation 710. In operation 710 the proper template for entry of squad's is selected for displaying to the user. Thereafter, in operation 720 the name of the squad is entered by the user. In operation 730 the type of squad is entered by the user. The type of squad may include offense, defense and special teams. In operation 740 the appropriate player list is then made available to the user for selection. Then in operation 750 players are added or deleted from the squadron. In operation 760 it is determined whether the created squadron should be saved. If the squadron should be saved then processing proceeds to operation 770 where the file is saved under the filename of the squadron. From either operation 760 or 770 processing then proceeds to operation 780 where it is determined if a new squadron should be created or modified. If a new squadron is to be created or modified than processing loops back to operation 720. Otherwise processing proceeds to operation 790 where processing terminates.

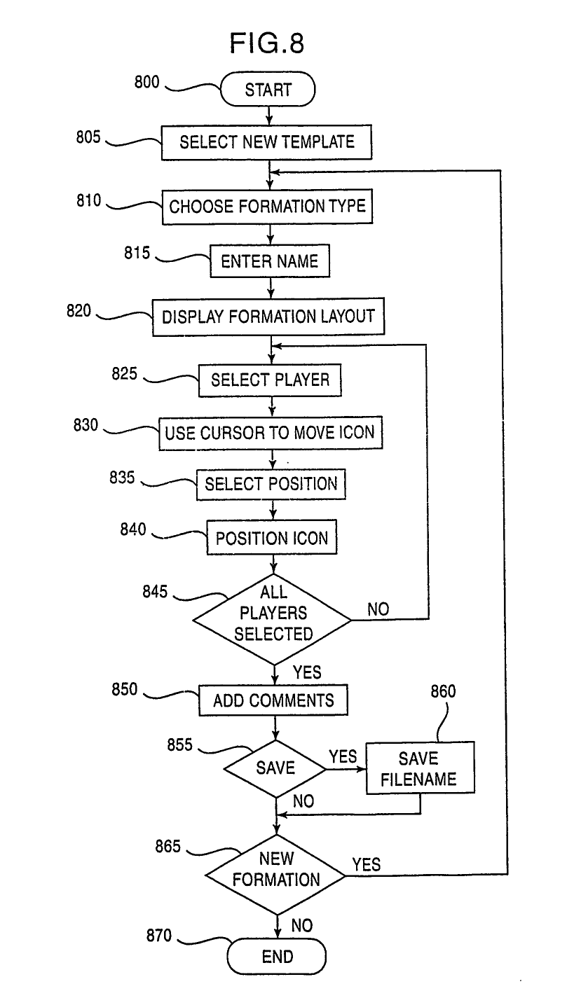

FIG. 8 is a flowchart of the formation module (330) implemented for the plays creation module (300) shown in FIG. 3 in an example embodiment of the present invention. The formation module (330) is used to create initial position placement for a squad of players. This initial placement of a squad of players makes creation of plays simpler since the plays may start from preset positions. The formation module (330) begins execution in operation 800 and immediately proceeds to operation 805. In operation 805 an appropriate template/form is displayed to the user for entry of data. In operation 810 a formation type is selected. This formation type may be, but not limited to, offense, defense and special teams. Processing then proceeds to operation 815 where the name of the formation is entered by the user. Once the name of the formation is entered processing then proceeds to operation 820 where the layout of the formation is displayed to the user. In operation 825 a player can be selected by user by clicking an icon in the formation layout. Thereafter in operation 830 the icon may be moved by the user to a given location in the formation utilizing the cursor. Processing then proceeds to operation 835 were a position is chosen by the user utilizing a drop list. Then in operation 840 icons can further be positioned utilizing editing tools. Processing then proceeds to operation 845 where it is determined if all players have been selected. If all players have not been selected then processing returns to operation 825. Otherwise if all players have been selected then processing proceeds from operation 845 to operation 850. In operation 850 comments may be entered relating to specific players so as to facilitate learning their positions in the future. In operation 855 it is determined whether this formation should be saved. If this formation should be saved then processing proceeds to operation 860 where the formation is saved under the appropriate filename. Processing then proceeds from operation 855 or 860 to operation 865 where it is determined if a new formation is desired to be entered. If a new formation is to be entered then processing loops back to operation 810. Otherwise processing proceeds to operation 870 where processing terminates.

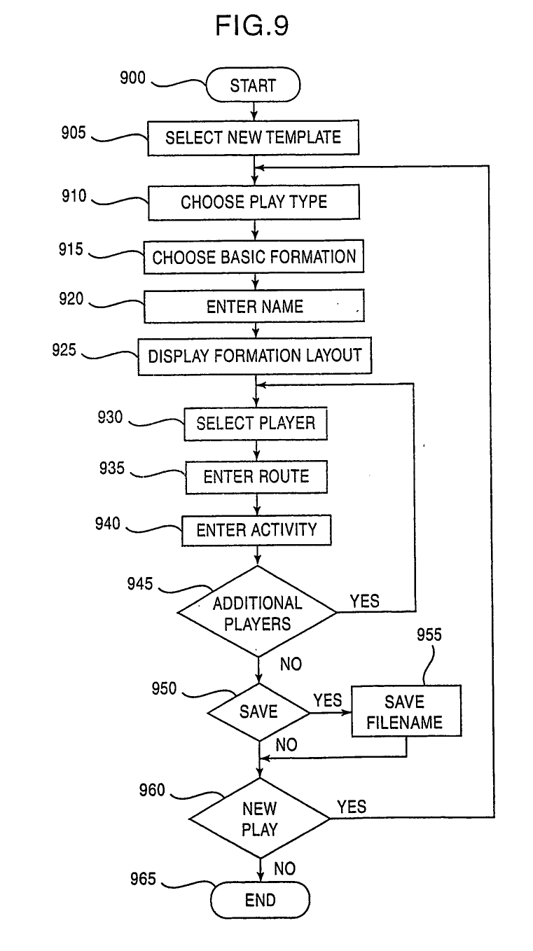

FIG. 9 is a flowchart of the play module (340) implemented for the plays creation module (300) shown in FIG. 3 in an example embodiment of the present invention. The play module (340) takes preset squad formations created by the formation module (330) and then selects how and where the different players are to move. The play module (340) begins execution in operation 900 and immediately proceeds to operation 905. In operation 905 a new template/form is generated for display to the user in order for data to be entered. In operation 910 the play type is selected by the user. This play type may be, but not limited to, offense, defense or special teams. Thereafter, in operation 915 the basic formation created by the formation module (330) is selected by the user. In operation 920 the name for this play is entered by the user. Then in operation 925 the formation layout is displayed to the user. In operation 930 a player is selected by clicking on an icon in the formation layout or via a drop list. Once the player is selected processing then proceeds to operation 935 where using drawing tools the route for the player may be entered. Then in operation 940 the activity engaged in by the player during the route may be entered. Once the route and activity have been entered processing then proceeds to operation 945 where it is determined if additional players need to have their routes and activities entered. If additional players need to have their routes and activities entered then processing loops back to operation 930. Otherwise processing proceeds to operation 950 where it is determined if this particular play should be saved. If this particular play should be saved then processing proceeds to operation 955 where the file is saved under the play filename. Processing then proceeds from operations 950 or 955 to operation 960. In operation. 960 it is determined whether a new play is desired to be entered at this time. If the entry of a new play is desired then processing loops back to operation 910. Otherwise processing proceeds to operation 965 where processing terminates.

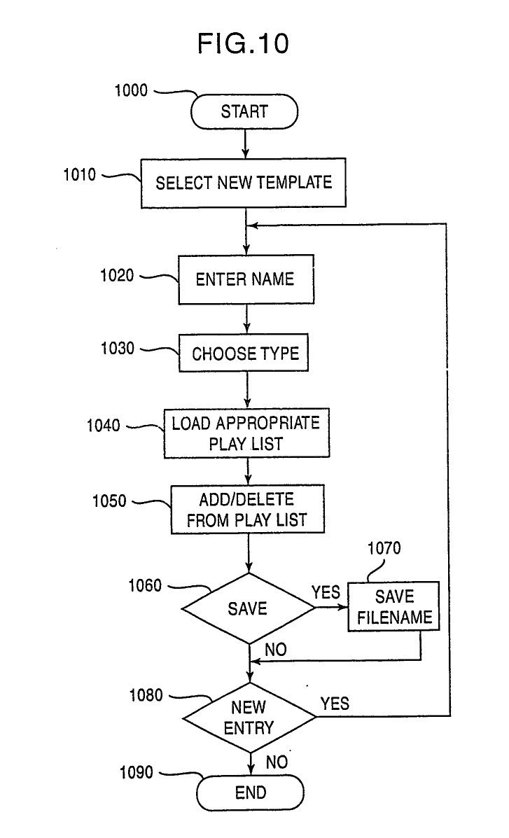

FIG. 10 is a flowchart of the playbook module (360) implemented for the plays creation module (300) shown in FIG. 3 in an example embodiment of the present invention. A playbook is a collection of plays usually divided into various broad categories. These categories would include offensive plays, defensive plays and special teams. Further subdivision may include all passing plays utilized by the offense.

The playbook module (360) begins execution in operation 1000 and immediately proceeds to operation 1010. In operation 1010 an appropriate template/form is selected for display to the user. Thereafter, processing proceeds to operation 1020 where the name of the play is chosen for the playbook. In operation 1030 the type of play is selected. This play type may include offensive plays, defensive plays, and special teams. In operation 1040 the appropriate play list is loaded having plays generated by the play module (340). Then in operation 1050 a play is added or deleted from the play list thereby changing the playbook. Thereafter, processing proceeds to operation 1060 where it is determined if the playbook is to be saved. If the playbook is to be saved then processing proceeds to operation 1070 where the playbook is saved under the appropriate filename. Processing then proceeds from either operation 1060 or 1070 to operation 1080 where it is determined if a new entry in the playbook is to be made. If a new entry is required then processing loops back to operation 1020. However, if no new entry is required then processing proceeds to operation 1090 where processing terminates.

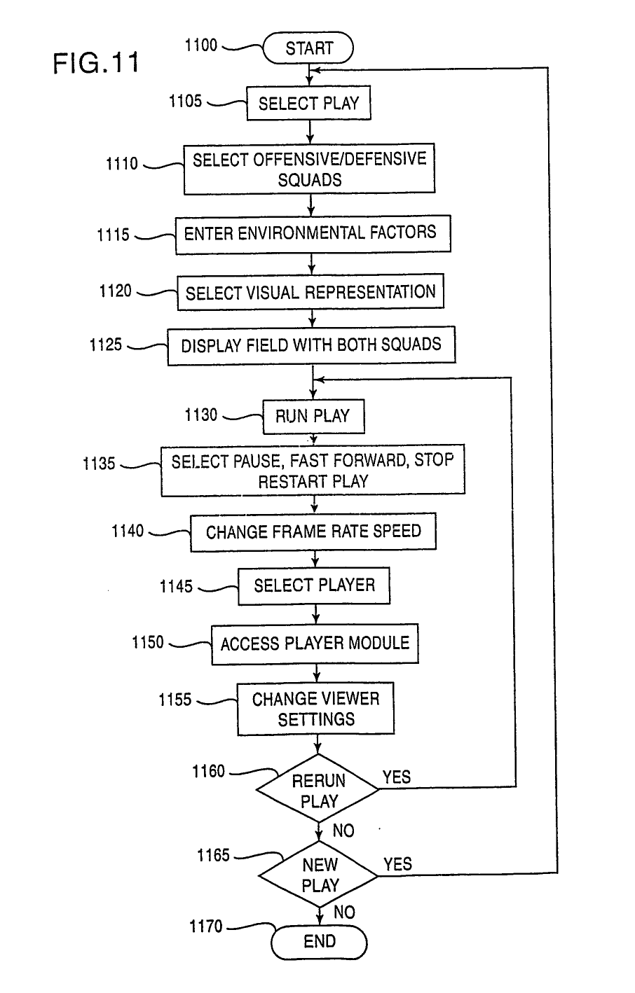

FIG. 11 is a flowchart of the run designed play module (350) implemented for the plays creation module (300) shown in FIG. 3 in an example embodiment of the present invention. The run designed play module (350) is used to execute plays created by the play module (340) utilizing player attributes entered using the player module (310). The run designed play module (350) also allows for changing of player attributes as well as players to simulate different outcomes.

The run designed play module (350) begins execution in operation 1100 and immediately proceeds to operation 1105. In operation 1105 a play created by the play module (340) is selected. In operation and 1110 the offensive and defensive squads are selected. Thereafter, the user has the option in operation 1115 of entering environmental factors, such as weather, that may impact the play. In operation 1120 the visual representation for the play is designated. This visual representation may include a two-dimensional overhead view, a two-dimensional side view, or a three-dimensional animated player view. The two-dimensional overhead view would utilize icons to represent players as is usually found in a standard playbook. The three-dimensional animated player view would utilize animated players instead of icons and different possible camera angles.

Still referring to FIG. 11, processing then proceeds to operation 1125 where the field of play is displayed with the initial squads and formations. Thereafter, in operation 1130 the play is executed as created by the play module (340) based on the player attributes entered using the player module (310). In operation 1135 the user has the option of pausing, fast forwarding, stopping and restarting the play at any time during execution. Thereafter, in operation 1140 the user may change the frame rate at which the play is executed. During the execution of the play the user may select in operation 1145 a player by clicking upon that icon or animated player. Thereafter, in operation 1150 the player module (310) may be activated in order to change the player attributes. Further, the makeup of the squad may be changed by activation of the squad creation module (320). In operation 1155 the user has the option of changing the viewer settings in order to modify such attributes as camera angles or viewing position. In operation 1160 it is determined whether the user desires to rerun the play. If the user wants to rerun the play then processing loops back to operation 1130. Otherwise processing proceeds to operation 1165 where it is determined if a new play is desired. If a new play is desired then processing loops back to operation 1105. If a new play is not desired then processing proceeds to operation 1170 where processing terminates.

FIG. 12 is a flowchart of the player specific camera viewing module (410) implemented for the viewing module (400) shown in FIG. 4 in an example embodiment of the present invention. The player specific camera viewing module (410) is used to assist a player in studying plays with his own position on the field as a focal point. During the execution of the player specific camera viewing module (410) none of the usually modifiable features such as playing conditions and player identities may be altered. However, viewing features such as camera angles may be modified so that a player may view the play from his own position on the field.

Referring to FIG. 12, the player specific camera viewing module (410) begins execution in operation 1200 and immediately proceeds to operation 1205. In operation 1205 a play created by the play module (340) is selected for viewing on the system viewer illustrated in FIG. 1. Thereafter, in operation 1210 the field and squads along with the environmental conditions is selected for viewing by the user. In operation 1215 the player to be keyed upon is selected by the user. Then in operation 1220 the field and squads are displayed to the user. The field and squads may take the form of a two-dimensional overhead view or a three-dimensional animated player view. In operation 1225 the play is executed. Then in operation 1230 the user has the option of changing the camera viewing angle so that the play execution may be viewed from the player's helmet. In operation 1235, the user has the option of pausing, fast forwarding, stopping and restarting the play any time during execution of the play. In operation 1240 the player may change the frame rate speed at which the play is viewed. Therefore, the playback speed for the play may be speeded up or slowed down depending on the users preference. Processing then proceeds to operation 1245 where the user has the option of viewing a textual description of the play. Thereafter processing proceeds to operation 1250 where the user may rerun the play if he so desires. Processing loops back to operation 1225 if the rerunning of the play is desired. If rerunning of the play is not desired then processing proceeds to operation 1255 where a snapshot of a particular frame may be taken by the user. Then in operation 1260 the user has the option of exporting the play in the form of a movie if desired. Thereafter, in operation 1265 it is determined whether the user desires a new play to be viewed. If the user desires the viewing of a new play then processing loops back to operation 1205. Otherwise processing proceeds to operation 1270 where processing terminates.

FIG. 13 is a flowchart of the exporting play viewing module (420) implemented for the viewing module (400) shown in FIG. 4 in an example embodiment of the present invention. The exporting play viewing module (420) is used to convert a play created or modified by the system into a movie format viewable on any player.

Referring to FIG. 13, the exporting play viewing module (420) begins execution in operation 1300 and immediately proceeds to operation 1310. In operation 1310 a new template/form is displayed to the user for entry of pertinent data. Thereafter in operation 1320 the type of play is entered by the user. This play type may be an offensive play, defensive play, or special teams. Then in operation 1330 the name of the play is entered by the user. In operation 1340 the format or type of movie desired is entered. In operation 1350 the name to be associated with the exported movie is entered by the user. Then in operation 1360 the movie is created and exported. Processing then proceeds to operation 1370 where it is determined if another movie is desired to be created. If a new movie is desired then processing loops back to operation 1320. However, if no new movie is desired then processing proceeds to operation 1380 where processing terminates.

FIG. 14 is a flowchart of the digital capture module (510) implemented for the digital movie module (500) shown in FIG. 5 in an example embodiment of the present invention. The digital capture module (510) utilizes the hardware shown in FIG. 2 in order to record an actual play.

Referring to FIG. 14, the digital capture module (510) begins execution in operation 1400 and immediately proceeds to operation 1410. In operation 1410 video camera (210) shown in FIG. 2 is physically placed on the field in order to view the game. In operation. 1420 the filming of the play begins when user desired. Thereafter processing proceeds to operation 1430 where at the user discretion the film may be edited. Once the film is edited the film is converted to the digital format. Then processing proceeds to operation 1450 where the movie is saved in digital format. Then in operation 1460 the movie may be imported into the remainder of the system. Processing then proceeds to operation 1470 where processing terminates.

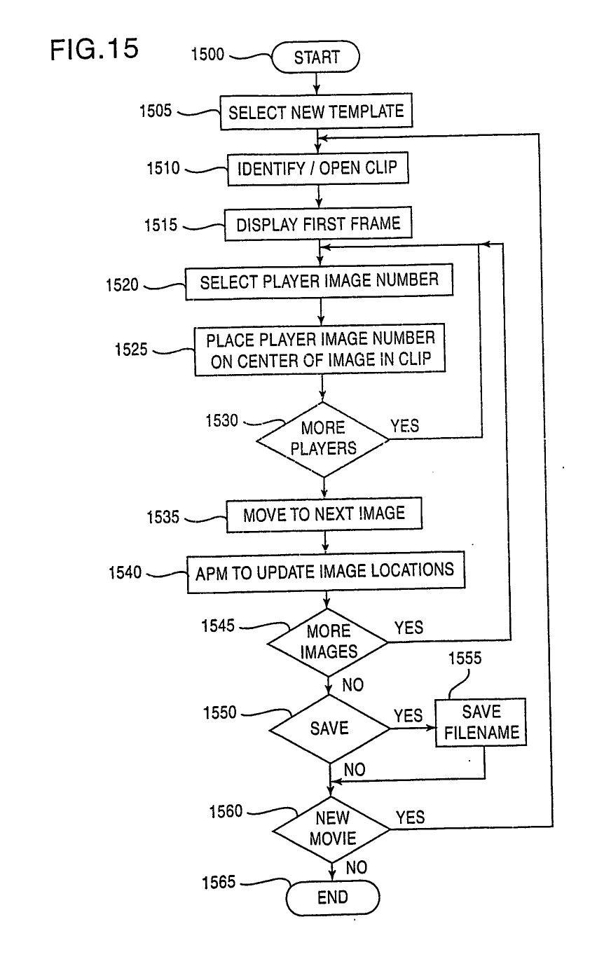

FIG. 15 is a flowchart of the capture module (520) implemented for the digital movie module (500) shown in FIG. 5 in an example embodiment of the present invention. The capture module (520) is used to import actual plays digitally recorded by the digital capture module (510). The capture module (520) utilizes a well-known technology known as Automatic Player Movement to track player movements from frame to frame utilizing color matching as well as algorithms to calculate future movement based on previous activity.

Referring to FIG. 15, the capture module (520) begins execution in operation 1500 and immediately proceeds to operation 1505. In operation 1505 a new template/form is displayed to the user for entry of data. In operation 1510 a particular film clip is identified and opened based on user input. Thereafter, in operation 1515 the first frame of the film clip is displayed to the user. In operation 1520 a player image number identifying each player on the field is entered by the user. Thereafter, in operation 1525 this player image number is placed on the center of the image in the film clip. In operation 1530 it is determined whether additional players need to be identified. If additional players need to be identified then processing loops back to operation 1520. However, if all players have been identified then processing proceeds to operation 1535. In operation 1535 the user then moves to the next image or frame. Thereafter in operation 1540 the Automatic Player Movement (APM) updates the image locations for each player. Then in operation 1545 it is determined if more images exist to be processed. If more images exist then processing loops back operation 1520. However if no further images exist then processing proceeds to operation 1550. In operation 1550 it is determined whether this film clip should be saved. If the film clip should be saved then processing proceeds to operation 1555 where the film clip is saved under a selected filename. Processing then proceeds from either operation 1550 or operation 1555 to operation 1560 where it is determined if a new movie needs to be processed. If a new movie needs to be processed then processing loops back to operation 1510. However, if no new movie needs to be processed then processing proceeds to operation 1565 where processing terminates.

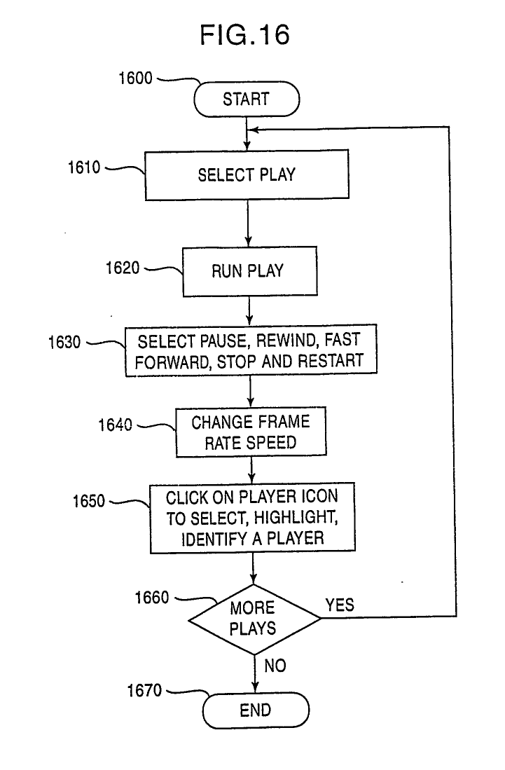

FIG. 16 is a flowchart of the run actual play module (530) implemented for the digital movie module (500) shown in FIG. 5 in an example embodiment of the present invention. The run actual play module (530) is used to watch actual plays generated by the capture module (520). In the run actual play module (530) all conditions regarding the play are set. Such set conditions would include weather conditions and player identities. However, the user may change the view at which the play is observed. For example, the play may be observed in a two-dimensional overhead view, a two-dimensional side view, or a three-dimensional view animated player view.

Referring to FIG. 16, processing begins in operation 1600 and immediately proceeds to operation 1610. In operation 1610 the user selects the play that is to be observed. Processing then proceeds to operation 1620 where the selected play is run. In operation 1630 the user may select to pause, rewind, fast forward, stop and start the play. The user may also select the viewing mode including a two-dimensional overhead view, a two-dimensional side view, and a three-dimensional view. Thereafter in operation 1640 the user may change the frame rate speed in order to view the play faster or slower. In operation 1650 the user may click on a player icon to select, highlight, and identify a particular player. In this manner for the user may focus on the activities of a particular player. Processing then proceeds to operation 1660 where it is determined if additional plays are to be viewed. If additional players are to be viewed then processing loops back to operation 1610. However, if no additional plays are to be viewed then processing proceeds to operation 1670 where processing terminates.

As will be appreciated by those skilled in the art, the present invention constitutes a quantum leap in the technology presently applied to athletic games or sports (e.g., American-style football) and achieves valuable features and advantages heretofore not available in the prior art.

These valuable features and advantages may be summarized as follows:
Substantially reduced training time For example, cutting down the training and “seasoning” time of a newly-drafted highly-paid young quarterback (from 3-4 years to 1 to 2 years) translates into a substantial cost reduction for the team.
Substantially reduced risk of injuries. By moving a large part of the training from the practice field into the classroom (or players' homes) injuries during practice are substantially reduced, if not eliminated. An NFL team may have a payroll of roughly $75 million, including quarterbacks, running backs, wide receivers, cornerbacks, linebackers, etc.; and a serious injury to a key player—which puts that player on the disabled list—translates into a big blow to the team's prospects for the season and, financially, a potential loss.
A substantially improved analytical tool. With this tool, the team can strategically tailor its plays (offensive, defensive and/or special teams) to the physical and mental attributes of the teams' respective players.
A substantially improved teaching and learning tool. With this tool players can view actual in game situations as if through their eyes as opposed to traditional ‘side line’ or ‘end zone’ views. These traditional views are not as the player views the game and this tool rectifies this shortcoming.

While we have shown and described only a few examples herein, it is understood that numerous changes and modifications as known to those skilled in the art could be made to the present invention. Therefore, we do not wish to be limited to the details shown and described herein, but intend to cover all such changes and modifications as are encompassed by the scope of the appended claims.

I claim

1. A method for simulating an athletic event, comprising:
entering players for positions in a squad on an offensive, defensive or special team, wherein each player has vital statistics, general attributes, offensive/defensive attributes and specialized attributes which predict athletic performance;
placing each player in a formation;
establishing a play based on the formation in which the moving pattern and activity of each player is defined;
simulating the play by having each player executing the moving pattern and activity as modified by the vital statistics, general attributes, offensive/defensive attributes and specialized attributes associated with each player, wherein the outcome of the play is based upon the moving patterns and activities as modified by the attributes associated with each player.

2. The method for simulating an athletic event recited in claim 48, wherein the vital statistics comprise the player's height and weight, wherein the general attributes comprise acceleration, agility awareness, elusiveness, jumping, speed, stamina, and strength, wherein the offensive/defensive attributes comprise breaking tackles, catching, pass blocking, run blocking, throwing accuracy, and throwing power, wherein the specialized attributes comprise injury recovery toughness, instinct and experience.

3-5. (canceled)

6. The method for simulating an athletic event recited in claim 1, further comprising:
entering each play in a playbook categorized according to the type of play.

7. The method for simulating an athletic event recited in claim 1, further comprising:
viewing the play as either a two-dimensional overhead view, a two-dimensional side view, or a three-dimensional animated player view and further comprising exporting the play established in the form of a movie.

8. (canceled)

9. A system for simulating an athletic event, comprising:
a player module to enter players for positions in a squad on an offensive, defensive or special team, wherein each player has attributes which predict athletic performance;
a play module to establish a play based on a formation in which the moving pattern and activity of each player is defined; and
a run designed play module to simulate the play by having each player executing the moving pattern and activity as modified by the vital statistics, general attributes, offensive/defensive attributes and specialized attributes associated with each player, wherein the outcome of the play is based upon the moving patterns and activities as modified by the attributes associated with each player.

10. The system for simulating an athletic event as recited in claim 9, further comprising:
a squad creation module to create a squad of players based upon the players entered using the player module, wherein each squad of players is associated with some specific game function, further comprising:
a formation module to establish the formation using the squad of players, further comprising:
a playbook module to enter each play in a playbook categorized according to the type of play, further comprising:
a player specific camera viewing module to view the play as either a two-dimensional overhead view, a two-dimensional side view, or a three-dimensional animated player view, further comprising:
an exporting play module to export the play established in the form of a movie.

11-18. (canceled)

19. A computer program embedded in a computer readable medium for simulating an athletic event, comprising:
a player code segment to enter players for positions in a squad on an offensive, defensive or special team, wherein each player has attributes which predict athletic performance;
a play code segment to establish a play based on a formation in which the moving pattern and activity of each player is defined; and
a run designed play code segment to simulate the play by having each player executing the moving pattern and activity as modified by the vital statistics, general attributes, offensive/defensive attributes and specialized attributes associated with each player, wherein the outcome of the play is based upon the moving patterns and activities as modified by the attributes associated with each player.

20. The computer program for simulating an athletic event as recited in claim 19, further comprising:
a squad creation code segment to create a squad of players based upon the players entered using the player code segment, wherein each squad of players is associated with some specific game function, a formation code segment to establish for formation using the squad of players
a playbook code segment to enter each play in a playbook categorized according to the type of play,
a player specific camera viewing code segment to view the play as either a two-dimensional overhead view, a two-dimensional side view, or three-dimensional animated player view, and
an exporting play code segment to export he play established in the form of a movie.

21-28. (canceled)

29. A system for capturing real world plays and importing these real world plays in digital format for viewing in different modes, comprising:
a digital capture module to record and convert video images into digitally formatted images;
a capture module to identify and track individual players in the digitally formatted images; and
a run actual play module to view the digitally formatted images and highlight individual players from one scene to the next.

30. The system recited in claim 29, wherein the capture module is able to track individual players based on color matching, wherein run actual play module is able to view the digitally formatted images in a two-dimensional overhead view a two-dimensional side view or a three-dimensional animated player view.

31. (canceled)

32. A computer program embodied on a computer readable medium for capturing real world plays and importing these real world plays in digital format for viewing in different modes, comprising:
a digital capture code segment to record and convert video images into digitally formatted images;
a capture code segment to identify and track individual players in the digitally formatted images; and
a run actual play code segment to view the digitally formatted images and highlight individual players from one scene to the next.

33. The computer program recited in claim 32, wherein the capture code segment is able to track individual players based on color matching, wherein run actual play code segment is able to view the digitally formatted images in a two-dimensional overhead view, a two-dimensional side view, or a three-dimensional animated player view.

34. (canceled)

35. A method for capturing real world plays and importing these real world plays in digital format for viewing in different modes, comprising:
recording and converting video images into digitally formatted images;
identifying and tracking individual players in the digitally formatted images; and
viewing the digitally formatted images and highlight individual players from one scene to the next.

36. The system recited in claim 35, further comprising tracking individual players based on color matching, further comprising viewing the digitally formatted images in a two-dimensional overhead view, a two-dimensional side view, or a three-dimensional animated player view.

37. (canceled)

38. A method of simulating at least a portion of an athletic game or sport and for at least one player on a team participating in that game or sport, thereby facilitating the training of said one player under simulated game conditions and in the classroom rather than on the playing field or arena, and thereby substantially compressing the training time while avoiding a potential injury to said one player on the practice field or arena; comprising the steps of, first,
presenting at least one of the team's defensive or offensive formations and intended subsequent play; and second,
presenting the team's opponent's likely action or reaction in response thereto, respectively; such that the first and second presentations are viewed from the position of said one player's own eyes had said one player been on the playing field or arena rather than from the perspective of a spectator.

39. The method of claim 38, further including the steps of
presenting all of the team's defensive or offensive formations and plays and the team opponent's likely actions or reactions in response thereto, and
customizing the presentations for each of the team's respective players on those formations and plays, further including the step of factoring in the capabilities for each of the team's respective players, thereby analyzing each of the team's formations and plays and determining which players on the team should be assigned to the respective formations and plays, and thereby tailoring the team to the opponent and tending to maximize the likelihood of the team beating its opponent.

40. (canceled)

41. A method for simulating an athletic event, comprising:
entering players for positions in a squad on an offensive, defensive or special team, wherein each player has attributes which predict athletic performance;
placing each player in a formation;
establishing a play based on the formation in which the moving pattern and activity of at least one player is defined;
simulating the play by having the at least one player executing the moving pattern and activity as modified by the vital statistics, general attributes, offensive/defensive attributes and specialized attributes associated the at least one player, wherein the outcome of the play is based upon the moving patterns and activities as modified by the attributes associated with the at least one player.

42. The method for simulating an athletic event recited in claim 51, wherein the vital statistics comprise the player's height and weight, wherein the general attributes comprise acceleration, agility awareness, elusiveness, jumping, speed, stamina, and strength, wherein the offensive/defensive attributes comprise breaking tackles, catching, pass blocking, run blocking, throwing accuracy, and throwing power, wherein the specialized attributes comprise injury recovery, toughness, instinct and experience.

43-45. (canceled)

46. A system for simulating an athletic event, comprising:
a player module to enter players for positions in a squad on an offensive, defensive or special team, wherein at least one player has vital statistics, general attributes, offensive/defensive attributes and specialized attributes which predict athletic performance;
a play module to establish a play based on a formation in which the moving pattern and activity of the at least one player is defined; and
a run designed play module to simulate the play by having the at least one player executing the moving pattern and activity as modified by the vital statistics, general attributes, offensive/defensive attributes and specialized attributes associated with the at least one player, wherein the outcome of the play is based upon the moving patterns and activities as modified by the vital statistics, general attributes, offensive/defensive attributes and specialized attributes associated with the at least one player.

47. A computer program embodied on a computer readable medium for simulating an athletic event, comprising:
a player code segment to enter players for positions in a squad on an offensive, defensive or special team, wherein at least one player has vital statistics, general attributes, offensive/defensive attributes and specialized attributes which predict athletic performance;
a play code segment to establish a play based on a formation in which the moving pattern and activity of the at least one player is defined; and
a run designed play code segment to simulate the play by having the at least one player executing the moving pattern and activity as modified by the vital statistics, general attributes, offensive/defensive attributes and specialized attributes associated with the at least one player, wherein the outcome of the play is based upon the moving patterns and activities as modified by the vital statistics, general attributes, offensive/defensive attributes and specialized attributes associated with the at least one player.

48. The method of claim 1, wherein the attributes associated with each player comprise at least one of the players vital statistics, general attributes, offensive/defensive attributes and specialized attributes.

49-51. (canceled)
